(19) United States
(12) Patent Application Publication
(10) Pub. No.: US 2014/0140709 A1
(43) Pub. Date: May 22, 2014

(54) APPARATUS AND METHOD FOR A FREQUENCY SPECIFIC ANTENNA AND RECEIVER

(71) Applicant: William A. Ganter, Boulder, CO (US)

(72) Inventor: William A. Ganter, Boulder, CO (US)

(73) Assignee: Custom Link Corportion, Boulder, CO (US)

(21) Appl. No.: 14/133,772

(22) PCT Filed: Jul. 18, 2012
(86) PCT No.: PCT/US2012/047222

§ 371 Date: Dec. 19, 2013

Related U.S. Application Data
(60) Provisional application No. 61/509,698, filed on Jul. 20, 2011.
(60) Provisional application No. 61/538,217, filed on Sep. 23, 2011.

(51) Int. Cl. H04B 10/61; H01Q 21/08

(52) U.S. Cl. CPC H04B 10/6151; H01Q 21/08
USPC 398/202; 343/844

(57) ABSTRACT

A frequency specific receiver and method can receive a transmitted polarized carrier signal wave, the carrier signal wave having a carrier frequency, encoding one or more data bits, includes a synchronization filter to determine a reference time at 0π of the carrier signal wave from a forward wave received at a forward antenna element and a rear wave received at a rear antenna element, positioned apart from one another by a distance of ¼ wavelength of the transmitted carrier signal wave and oriented in a polarization direction of the transmitted carrier signal wave. A first A/D converter samples the forward wave at π/2, π, 3π/2 and 2π radians and a second A/D converter samples the rear wave at π/2, π, 3π/2 and 2π radians. A control processor decodes a value of the encoded data bit by calculation of an average computation and a calculation of a correlation computation.

This application claims the benefit of U.S. Provisional Application Ser. No. 61/509,698, filed Jul. 20, 2011, and U.S. Provisional Application Ser. No. 61/538,217, filed Sep. 23, 2011, the entirety of which is incorporated herein by reference.

### BACKGROUND

1. Field of the Invention

This disclosure relates generally to antennae and receivers. In particular, an antenna and receiver is arranged to reduce the other Radio Frequency (RF) transmissions and background noise that are superimposed on a desired signal.

2. Related Art

Transmitters had previously been disclosed by that were referred to therein as Carrier State Modulation (CSM). They directly modulate a single frequency carrier by combinations of amplitude and/or phase. These transmission coding methods can also be called Direct Carrier Modulation (DCM). They do not mix baseband data content onto a carrier, as is common practice in wireless. Compared with traditional filter tuned baseband methods, CSM and DCM transmissions have the advantages of (1) single frequency transmission in a very narrow spectrum band, (2) a generally much higher data rate expressed as bps, (3) much greater spectral efficiency expressed as bps/Hz, and (4) minimal contributions to the noise floor. These benefits are obtained by processing the transmitted signal out from all other RF transmitters and broadband noise in the receiving antenna. This alternative approach to wireless data transmission may become preferred for some applications, and may help relieve the spectrum shortage and RF congestion in some frequency bands.

### SUMMARY OF THE INVENTION

A frequency specific receiver and method can receive a transmitted polarized carrier signal wave, the carrier signal wave having a carrier frequency, encoding one or more data bits, includes a synchronization filter to synchronize a forward wave received at a forward antenna element with a rear wave received at a rear antenna element, the forward antenna element and the rear antenna element positioned apart from one another by a distance of ¼ wavelength of the transmitted polarized carrier signal wave and oriented in a polarization direction of the transmitted polarized carrier signal wave. A first analog-to-digital (A/D) converter samples the forward wave at π/2, π, 3π/2 and 2π radians from a reference time and a second A/D converter to sample the rear wave at π/2, π, 3π/2 and 2π radians from the reference time. A control processor is configured to decode a value of the encoded data bit by calculation of an Average Computation and a calculation of a Correlation Computation based on a received amplitude. An output interface outputs the value of the data bit to a user. The data bit is encoded over n cycles of the carrier wave signal.

The Average Computation includes calculating a first forward wave average of a first forward wave sum of the π/2 A/D converter samples across the n cycles that encode the data bit and dividing the first forward wave sum by n, calculating a first rear wave average of a first rear wave sum of the π/2 A/D converter samples across the n cycles that encode the data bit and dividing the first rear wave sum by n, calculating a second forward wave average of a second forward wave sum of the 3π/2 A/D converter samples across the n cycles that encode the data bit and dividing the second forward wave sum by n, and calculating a second rear wave average of a second rear wave sum of the 3π/2 A/D converter samples across the n cycles that encode the data bit and dividing the second rear wave sum by n.

When the data bit is phase encoded in the carrier wave signal, then the Average Computation includes:
a. incrementing an In-Phase Score based on a comparison of the first forward wave average with one or more predetermined average In-Phase levels,
b. incrementing the In-Phase Score based on a comparison of the first rear wave average with one or more predetermined average In-Phase levels,
c. incrementing an Out-Phase Score based on a comparison of the second forward wave average with one or more predetermined average Out-Phase levels, and
d. incrementing the Out-Phase Score based on a comparison of the second rear wave average with one or more predetermined average Out-Phase levels.

When the data bit is on/off encoded in the carrier wave signal, then the control processor calculation of the Average Computation includes:
a. incrementing an On-Score based on a comparison of the first forward wave average with one or more predetermined average On-Score levels,
b. incrementing the On-Score based on a comparison of the first rear wave average with one or more predetermined average On-Score levels,
c. incrementing the On-Score based on a comparison of the second forward wave average with one or more predetermined average On-Score levels,
d. incrementing the On-Score based on a comparison of the second rear wave average with one or more predetermined average On-Score levels.
e. incrementing an Off-Score based on a comparison of the first forward wave average with one or more predetermined average Off-Score levels,
f. incrementing the Off-Score based on a comparison of the first rear wave average with one or more predetermined average Off-Score levels,
g. incrementing the Off-Score based on a comparison of the second forward wave average with one or more predetermined average Off-Score levels, and
h. incrementing the On-Score based on a comparison of the second rear wave average with one or more predetermined average Off-Score levels.

The Correlation Computation includes pairing the A/D converter sample of the forward wave at π/2, π, 3π/2 and 2πradians with the rear wave A/D converter sample at π/2, π, 3π/2 and 2π radians so that the rear wave A/D converter sample is ¼ wavelength and π/2 in signal propagation behind the respective paired forward wave A/D converter sample. Accordingly, the pairings are

Pair1: the forward wave A/D sample at 0π with the rear wave A/D sample at π/2;

Pair2: the forward wave A/D sample at let with the rear wave A/D sample at 3π/2;

Pair3: the forward wave A/D sample at π/2 with the rear wave A/D sample at 1π; and

Pair4: the forward wave A/D sample at 3π/2 with the rear wave A/D sample at 2π.

When the data bit is phase encoded in the carrier wave signal, calculation of the Correlation Computation includes incrementing the In-Phase Score based on a comparison of an arithmetic combination of A/D converter samples in each pair with one or more predetermined correlation In-Phase levels and incrementing the Out-Phase Score based on a comparison of an arithmetic combination of A/D converter samples in each pair with one or more predetermined correlation Out-Phase levels.

When the data bit is on/off encoded in the carrier wave signal, then the control processor calculation of the Correlation Computation includes incrementing the On-Score based on a comparison of an arithmetic combination of A/D converter samples in each pair with one or more predetermined correlation On-Score levels and incrementing the Off-Score based on a comparison of an arithmetic combination of A/D converter samples in each pair with one or more predetermined correlation Off-Score levels.

The value of the data bit is determined from a comparison of the In-Phase Score to the Out-Phase Score or On-Score to the Off-Score based on whether the data bit was phase encoded or on/off encoded.

### BRIEF DESCRIPTION OF THE DRAWINGS

FIGS. 1A-1C illustrate two geometric configurations on the receiving antenna enclosed in an RF shield embodiment of the present invention;

FIG. 2 is a block diagram of an embodiment of a receiver in accordance with the present invention;

FIG. 3 illustrates the RF in the electrically isolated forward and rear elements of the antenna of FIG. 1, which includes 12 bits of the signal that is phase coded in n=3 Hertz cycles of the carrier wave, together with the In-Phase Score and Out-Phase Score in accordance with a detection method of the present invention;

FIG. 4 illustrates the RF in the electrically isolated forward and rear elements of the antenna of FIG. 1, which includes 7 bits of the signal that is phase coded in n=5 Hertz cycles of the carrier wave, together with the In-Phase Score and Out-Phase Score in accordance with a detection method of the present invention;

FIG. 5 illustrates the RF in the electrically isolated forward and rear elements of the antenna of FIG. 1, which includes 6 bits of the signal that is amplitude coded in n=6 Hertz cycles of the carrier wave, together with the On-Score and the Off-Score in accordance with a detection method of the present invention.

### DETAILED DESCRIPTION OF THE INVENTION

The frequency specific antenna system of the present disclosure includes a dual element receiving antenna in a geometric configuration together with a synchronized receiver to decode one or more bits of digital data. The invention includes an antenna design for receiving directional single frequency transmissions. The methods herein, that are enabled by the antenna geometry of the present invention, describe two computations, hereinafter called the “Average” and “Correlation” Computations, as defined herein, that identify much of the other Radio Frequency (RF) transmissions and background noise that are superimposed in this receiving antenna along with the signal, together with novel detection methods that use these two computations for decoding the data bits that were transmitted as a CSM or DCM signal.

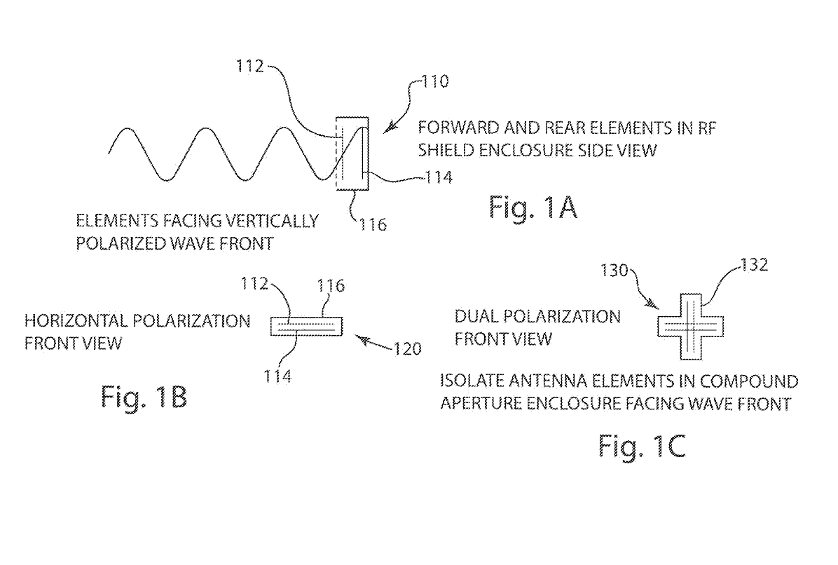

Hereinafter, the term “other transmissions”, “other frequencies”, “other signals” or “others” (when referring to transmissions) or similar such expressions means all RF in the receiving antenna other than the desired transmitted signal. The receiving antenna dipole elements illustrated in FIG. 1 are distinguished using the term “forward” and “rear” for the respective forward and rear elements. The term “signal” hereinafter refers to the data transmission to be detected by the methods of the present disclosure.

The Average Computation of the present disclosure reduces the effects of the other RF transmitters and the local noise by averaging the signal synchronized A/D samples at π/2 and 3π/2 in both the forward and rear antenna elements across all n Hertz cycles that code a data bit. The Correlation Computation exploits the antenna geometry embodiment illustrated in FIG. 1, having a quarter wavelength (λ) distance separation between the forward and rear antenna elements.

In an embodiment, the frequency specific antenna is enclosed by RF shielding with an aperture facing the polarized directional wave front. Another apparatus embodiment integrates two pairs of forward and rear elements at 90 degrees to one another to simultaneously receive signals transmitted in both horizontal and vertical polarizations.

The frequency specific electrically isolated forward and rear elements are individually capacitively coupled electrically to conduct the signal, two distinct analog RF waveforms for synchronized Analog-to-Digital (A/D) sampling in the receiver. The value of each coupling capacitor (C in farads) is selected so as to best match the inductance (L in Henrys) of the antenna element at signal frequency f. Matching of the coupling capacitor to the antenna inductance can be accomplished using equivalence 2πfC=1/(2πfL) as this choice of C maximizes the antenna element gain at signal frequency f, in addition to attenuating other frequencies that are both higher and lower than f (commonly referred to as antenna roll-off). The value of inductance L is proportional to the length of an antenna element, acting like small inductors in series.

In an embodiment, after synchronizing to the signal, these waveforms are each separately A/D sampled at four equally spaced times at π/2, π, 3π/2 and 2πradians after a reference time, t₀, that is the start of a signal crossing the zero threshold. The samples in the rear element time lag the forward samples by π/2, the time for the wave front to propagate forward by one quarter of its wavelength. The π and 2π samples from the forward element contain only the other transmissions and local noise as the signal is at a zero crossing at these sample times, and symmetrically, the synchronized π and 2πsamples of the rear element also only contain the other transmissions. Some portion of these other transmissions in the forward element will later arrive at the 3π/2 and π/2 samples of the rear antenna element, along with the desired signal. The Average and Correlation Calculations use both antenna elements to enhance the detection of the signal data bits.

Of course, as understood by those of ordinary skill, the Average and Correlation Calculations are repeated for each Hertz cycle after the reference time. On a second Hertz cycle the sampling could be considered as occurring at (2π+π/2), (2π+π), (2π+3π/2) and (2π+2π) radians. And, in general, the A/D sampling occurs at (2Kπ+π/2), (2Kπ+π), (2Kπ+3π/2) and (2Kπ+2π) radians, where K is any positive non-zero integer.

The present disclosure can be used as an alternative to filter tuning the signal from all RF in a receiving antenna. The single frequency carrier coding, of CSM or DCM type in a polarized directional wave front, arrives at the forward electrically isolated antenna element at the time of ¼ propagation at light speed prior to arriving at the rear element.

### Antenna Apparatus:

FIG. 1A illustrates a receiving antenna 110 for vertically polarized wave front. The distance between the forward element 112 and rear element 114 is ¼λ. For example, a 200 MHz carrier completes one Hertz wave cycle in 1/(200×10⁶) Sec=5 nsec, while one Hertz of the wave front propagates forward at light speed by approximately 1.5 meters. That is, the wavelength, λ=1.5 meters. Hence, a 200 MHz embodiment of the present invention would have the rear element ¼λ=1.5/4=0.375 meters behind the forward element and at different elevations as depicted in FIG. 1B. Further, the same π location in the wave front at the forward element arrives 1.25 nsec later at the rear element. That is, the 200 MHz carrier wave front traverses the ¼ λ of 0.375 meter distance between the antenna elements in ¼ of 5 nsec, which is 1.25 nsec.

RF shield enclosures 116 in FIG. 1A and FIG. 1B can reduce RF getting into the antenna elements from directions other than the signal wave front propagation direction.

The small elevation distance depicted in FIG. 1B and in FIG. 1C between the forward and rear elements can reduce the effects of the elements re-radiating onto each other, in time delay, within the enclosure. It may thus often be useful to include a thin layer of RF shielding between these height differences in order to better RF isolate the forward and rear elements from one another.

FIG. 1C shows a dual polarization 130 embodiment of the present invention. In this embodiment, the signal could be redundantly transmitted in both horizontal and vertical polarizations. Alternatively, this antenna configuration could simultaneously receive two independent channels of digital data having orthogonal polarizations. Further, the two data channels could use different carrier frequencies. It may be advantageous for these frequencies to be in an integer ratio like 100 to 90. Here, a synchronized block of 100 Hertz cycles on the higher frequency (say 200 MHz) and 90 Hertz cycles on the lower frequency (say 180 MHz) would complete their transmissions in the exact same time. Dual polarization antenna 130 is illustrated with a compound enclosure 132 but it should be recognized that various alternative enclosures and apertures could be designed. It should also be recognized that FIG. 1 side by side 110 and 120 enclosures in the same wave front direction would provide the equivalent receiving function as received in the 130 compound enclosure.

The rear antenna element 114 in these experiments receives less RF than the forward antenna element 112 as the wave front directions of the others will be misaligned with the signal wave front, and more of the local background noise would be shielded by the RF screen 116 enclosure. Specifically the rear element 114 was defined in the experiments to receive roughly 75% of the directional others getting into the aperture and the front element (the other 25% being absorbed into the aperture sides), and the local noise was uniquely random generated at each element, but was defined to be not as strong at the rear element further within the shielded enclosure. In actual deployments, these percentages will be entirely at random, hence the following methods do not depend on the values for the experiments presented herein to help explain the methods.

### Receiver Apparatus:

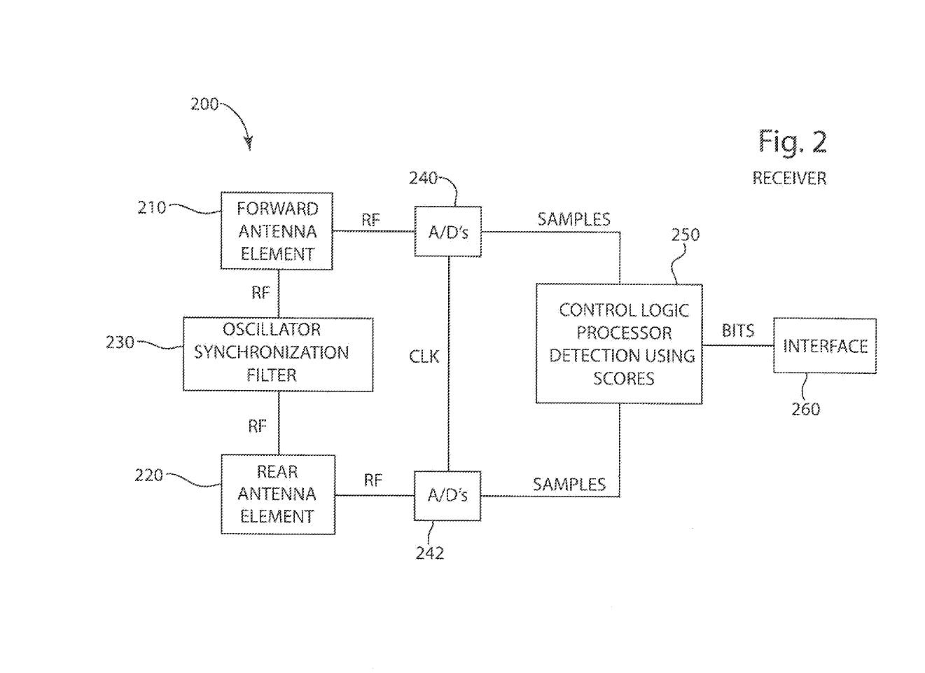

FIG. 2 illustrates a receiver 200 of the present invention that receives RF from both a forward antenna element 210 and RF from a rear antenna element 220. The received RF from each of the forward antenna element and the rear antenna element is split into the oscillator block 230 for synchronization to the carrier frequency and to generate 4 or more clock (CLK) timing pulses to the A/D sampler blocks 240, 242 associated with respective forward and rear antenna elements. A narrow band pass filter at frequency f can be used in the synchronization process, among other common approaches. The samples from A/D sampler blocks 240, 242 are provided to a processor and control logic block 250 for detection of the received data bits as described in more detail herein below. The detected data bits are provided to a user interface 260, which outputs the decoded data for use by the user. The user interface being, for example, a connection to a digital device, memory, a computer screen or data recorder.

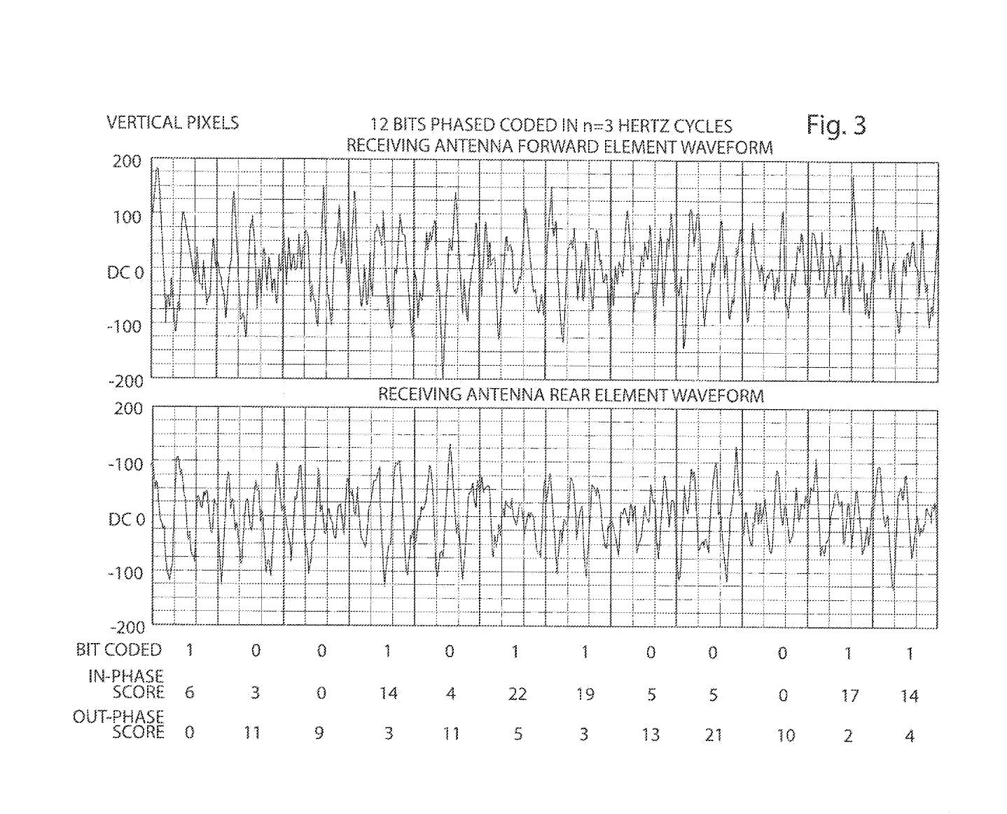

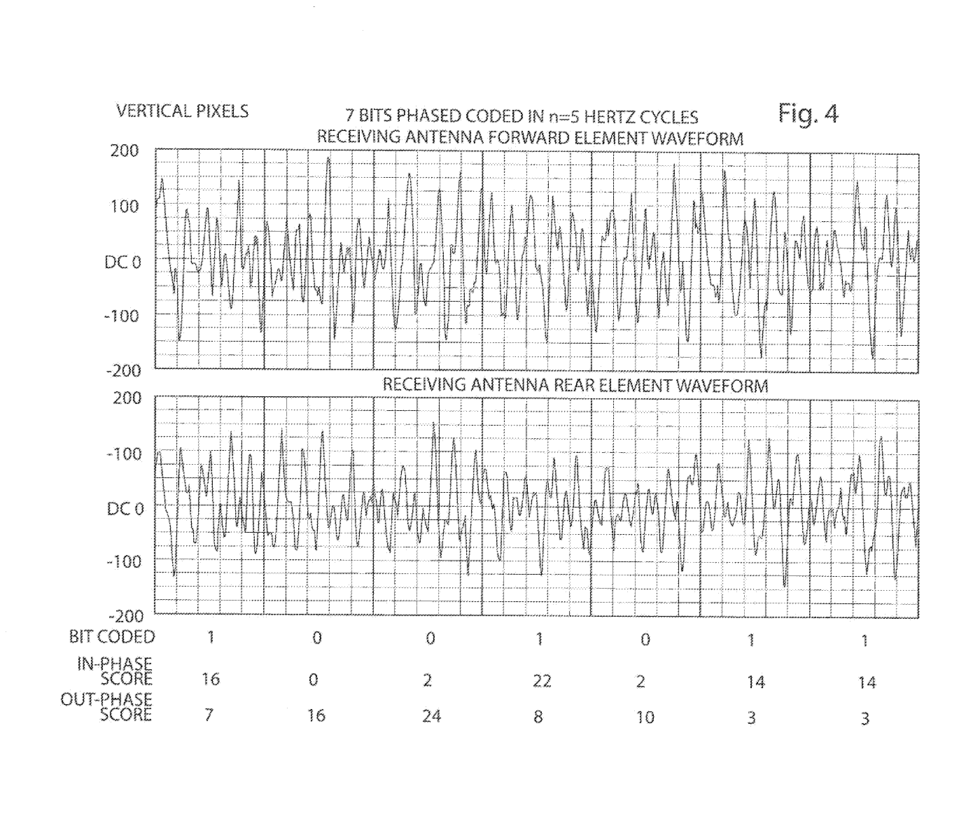

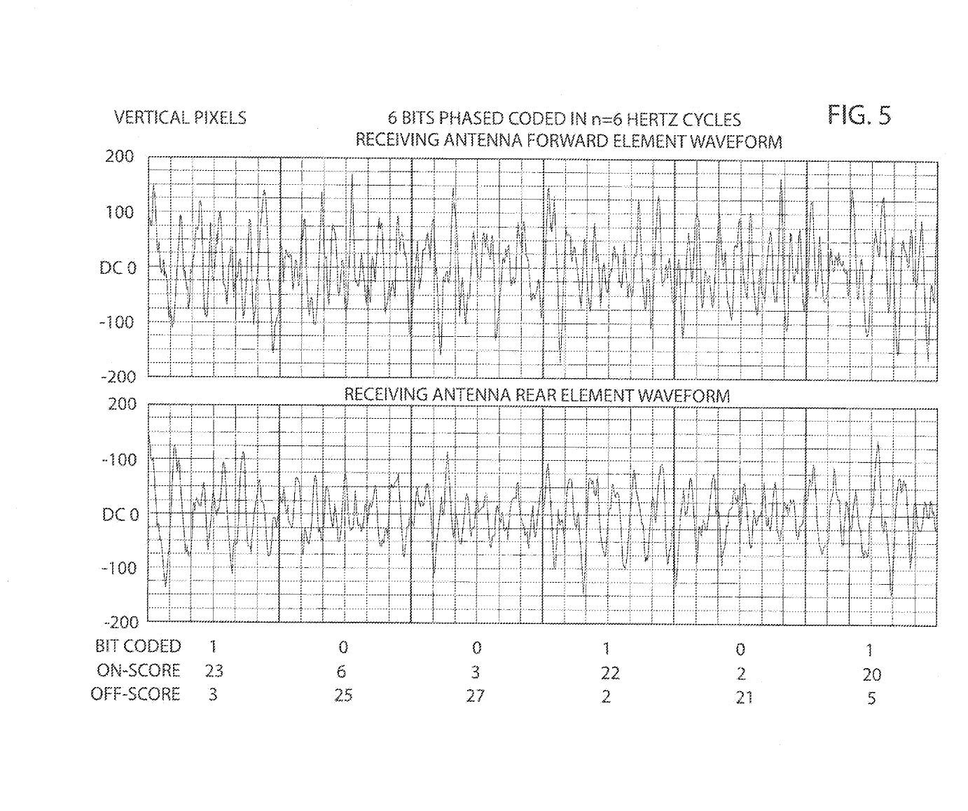

The detection of received data bits according to the present technique are computations that can be performed in processor 250. Processor 250 can support parallel and interleaved computations. Processor 250 can be multi-core or a gate array, or both. Processor 250 can contain embedded memory to support these method computations. These Average and Correlation computations result in what is referred to herein as an In-Phase Score and an Out-Phase Score for the simulated experiments of FIG. 3 and FIG. 4, and the On-Score and Off-Score of simulated experiment illustrated in FIG. 5. The In-Phase Score and the Out-Phase Score will be described for the simulated experiments illustrated in FIG. 3 and FIG. 4, and the On-Score and the Off-Score will be described in the simulated experiment illustrated in FIG. 5.

The experiments illustrated in FIG. 3 to FIG. 5 consist of a large number of random transmitters and local noise, superimposed as the RF being received in the forward and rear antenna elements. Some of the transmitters stay on for the duration of the graphic experiments, while others are only being received at random times and durations during these simulated experiments. In actual deployments of an antenna configuration of FIG. 1 and a receiver 200 of FIG. 2 of the present invention, the other RF will always be different, everywhere, all the time.

To understand the detection methods of the present technique, it may be helpful to consider the wave front at the forward element, where there are 4 equally spaced synchronized A/D samples at 2π (or 0π), π/2, π and 3π/2, and then again at 2π. Disregarding the local noise, the 0π and 1π it forward element samples are others only (the signal, if present, is at zero crossings), while the π/2 and 3π/2 A/D samples are others along with the desired signal.

Now consider the rear element with synchronized A/D samples at the same 2π(or 0π), π/2, π and 3π/2 positions in a Hertz cycle as the forward antenna element but at a ¼wavelength time later. In this case, the others in all of the A/D samples are at random phase offsets to the signal synchronization.

In the experiments of FIG. 3 and FIG. 4, the In-Phase Score and Out-Phase Score for bit detection are defined based upon the Average Computation and the Correlation Computation. These scores are tallied from value limit comparisons to the Average and Correlation Computations on the A/D samples from the forward and rear antenna elements.

### Simulated Experiments:

In the experiment illustrated in FIG. 3 the transmitted signal amplitude is 40 vertical pixels. This phase coded signal is in-phase for n=3 Hertz cycles to code a 1 bit and is 180 degrees out-of-phase for n=3 Hertz cycles to code a 0 bit. That is, in a phase coded signal the data bits are encoded by either transmitting a signal in-phase or out-of-phase with the carrier signal depending on the value of the data bit being encoded. Hence, a signal is always present. In the experiment illustrated in FIG. 4, which is also phase coded as in FIG. 3, the transmitted signal amplitude is lower at 35 vertical pixels, and the bits were coded in n=5 Hertz cycles.

FIG. 5 illustrates an experiment using a transmitted signal amplitude of 50 vertical pixels to code a 1 bit in n=6 Hertz cycles. This transmitter is off (zero amplitude and 0 vertical pixels) to code a 0 bit in n=6 Hertz cycles. This is an on/off coded signal of data bits from a transmitter of the single carrier frequency. That is, in an on/off coded signal the data bits are encoded by either transmitting a signal or not transmitting a signal depending on the value of the data bit being encoded. This transmitter is simpler than conventional carrier frequencies that are mixed with baseband content, while its propagation physics is the same as for any RF transmission. The On-Score and the Off-Score are tallied for the on/off transmitter of the FIG. 5 experiment. These scores, like the In-Phase and Out-Phase scores of FIG. 3 and FIG. 4, are also defined by value limit comparisons of the Average computation and the Correlation computation.

### Average Computation:

Average Computation is a mathematical process that adds the π/2 A/D samples across the n Hertz cycles and then divides this sum by n, and separately adds the 3π/2 A/D samples across the n Hertz cycles that encode a bit, then also divides this sum by n. These identical summations are performed separately for the forward and rear antenna element A/D samples. The π and the 2 πA/D samples are not used in the Average Computations, as they contain no signal. The others in the π/2 and 3π/2 A/D samples are at random and will tend to average out toward their zero expected value in this process, or at least may do so enough to indicate whether the present signal was coded in phase or out of phase for phase coding, and whether the signal was present or not for on/off coding. Herein, the π/2 summation divided by n Hertz cycles is denoted as “avg1”, and the 3π/2 summation divided by n is denoted as “avg2”.

An avg1 Average Computation is obtained from the forward antenna element of the π/2 A/D samples, which could be denoted as avg1f, and separately from the rear antenna element, which could be denoted as avg1r. Similarly, avg2f and avg2r can be used to denote the Average Computation of the 3π/2 A/D samples from the forward and rear antenna elements, respectively. However, because the Average Computation is performed separately in the identical way for both antenna elements, the “r” and “r” are not so denoted hereafter, instead just avg1 and avg2 for either element separately.

The avg1 and avg2 indications tend to improve when summing across a larger number n of Hertz cycles (i.e., a longer averaging of random variables). It should be realized that avg1 would likely be positive and avg2 would likely be negative, when the signal coding for a bit is in phase, and have the opposite signs when the signal coding for a bit is out of phase, here with avg1 tending negative and avg2 tending positive. In a similar manner for on/off coding of FIG. 5, avg1 would likely be positive and avg2 would likely be negative when the transmitter is on, while both avg1 and avg2 would likely tend to be near zero when the transmitter is off. However, due to the random others and noise, different and mixed values of avg1 and avg2 will occur, and occur more often in locations with greater RF activity relative to the received signal amplitude.

For simplicity of explanation herein, the same comparison limit values are applied to the Average Computations to form the In-Phase and Out-Phase Scores for the experiments of FIG. 3 and FIG. 4. However, it should be recognized that in actual deployments, the limit values can be dynamically selected after A/D sampling the others in the antenna elements, when no signal is being transmitted as compared with the signal transmitted in a training sequence or to the signal transmitted as the synchronization header. The comparison limit values so selected would be ones that optimized bit detection as measured by reduction in bit detection errors. The symbol “amp” is used hereinafter to denote the measured received signal amplitude. All detection rule comparisons of this disclosure are proportional to the amp of the received signal amplitude. This received amp is assumed to be substantially identical in the forward and rear antenna elements, and would be so with appropriate antenna directional alignment and enclosure aperture opening size.

The comparisons described below for incrementing the scores are symmetric relative to in-phase or out-of-phase coding. Also, the same comparisons are separately applied to the forward and rear element computations that were computed from their separate isolated forward and rear element A/D samplings.

An In-Phase Score is incremented by one count when avg1 (of the π/2 A/D's) is greater than (0.35*amp). No change is made to the In-Phase Score when avg1 is less than (0.35*amp) as such a value is either ambiguous to the bit coding or might better indicate an out-of-phase coding. As a bonus when avg1 is greater than (0.35*amp), the In-Phase Score will be incremented by another one count when the absolute value of (avg1−amp) is less than (0.26*amp), and by a third count when the absolute value of (avg1−amp) is less than (0.13*amp). These bonus counts are awarded when avg1 is close and closer, respectively, in value to the signal amplitude.

Symmetrically, the Out-Phase Score is incremented when the avg1 (of the π/2 A/D's) is less than (−0.35*amp). A second bonus count is added to the Out-Phase Score when the absolute value of (avg2+amp) is less than (0.26*amp) and a third bonus count is added when the absolute value of (avg2+amp) is less than (0.13*amp). These bonus scores are awarded when avg2 is close and closer in value to the signal amplitude. In further symmetry, the In-Phase Score is incremented by one when avg2 (of the 3π/2 A/D's) is less than (−0.35*amp).

Hence, in any comparison, either the In-Phase Score or the Out-Phase Score can be incremented, but never both and sometimes neither when the avg1 or avg2 value is in the ambiguous range between (0.35*amp) and (−0.35*amp). The maximum possible score due to the Average computation is thus 3 counts*2 summations (avg1 and avg2)*2 antenna elements (forward and rear)=12, and the minimum possible score is zero. The separate Correlation computation (defined below) is computed in parallel with the Average computation and this will usually add additional counts to the In-Phase and Out-Phase scores. Thus, the defined detection scores will have contributions from both the Average and the Correlation computations.

The Average Computation is treated with the same (limits 0.35*amp, 0.26*amp and 0.13*amp) for the on/off FIG. 5 experiment, with maximum score of 12 and minimum score of zero. Here, the On-Score is the same as the In-Phase Score for the phase coding of FIG. 3 and FIG. 4. However, the Off-Score is different. In the Off-Score, avg1 and avg2 are compared to absolute values around zero. The Off-Score is incremented by one count when the absolute value of avg1 is less than (0.35*amp), and a second count is added when the absolute value of avg1 is less than (0.26*amp), and a third count is added when the absolute value of avg1 less than (0.13*amp). The same unit increments add to the Off-Score when the absolute value of avg2 is less than (0.35*amp) and (0.26*amp) and (0.13*amp).

The multipliers of 0.35, 0.26 and 0.13 were determined experimentally to achieve the best result. By “best result” is meant that the determined multipliers when applied to received encoded data bits cause the Average Calculation to achieve a desired level of correspondence of the decoded data bits matching the encoded data bits. For example, a predetermined sequence of data bits can be sent and the optimum multipliers determined that best return the predetermined sequence of data bits. The multipliers can be different depending on the levels of unwanted other noise received by the antennae. Accordingly, the multipliers can be re-determined as necessary. It should also be appreciated that additional comparisons for score incrementing would be within the scope of the claims of this disclosure.

### Correlation Computation:

The Correlation computation uses all of the A/D samples, in forward and rear element pairs. These four pairings, herein designated as pair1, pair2, pair3 and pair4, are:

(pair1) the forward 0π A/D with the rear π/2 A/D (signal from 0 to amp),
(pair2) the forward 1π A/D with the rear 3π/2 A/D (signal from 0 to −amp),
(pair3) the forward π/2 A/D with the rear 1π A/D (signal from amp to 0), and
(pair4) the forward 3π/2 A/D with the rear 2π A/D sample (signal from −amp to 0).
The pairs are selected so that the rear A/D is always ¼ wavelength and π/2 in signal propagation behind the forward A/D. The theory underlying the Correlation computation posits that the phase of the composite others will sometimes not shift much relative to the signal transition during these propagations from the forward element to the rear element. The composite others have a different amplitude at every possible relative phase.

The Correlation computation consists of two calculations on each pair hereinafter denoted as (pair−amp) and (pair+amp). The (pair−amp) value is computed as the absolute value of the forward A/D sample minus the rear A/D sample minus amp, and the (pair+amp) is computed as the absolute value of the forward A/D sample minus the rear A/D sample plus amp, in each of these four pairings. Paid and pair3 are for the π/2 A/D samples and pair2 and pair4 are for the 3π/2 A/D samples. In each pair, one of the A/D samples contains signal and the others (at π/2 or 3π/2), while the other A/D in the pair (at 0π, or 2π) is the others only.

The Correlation is on the amplitude transitions of the others, with the expectation that these others amplitudes in the four defined pairs will sometimes be of similar frequency to the signal, but at random may not be so. However, because one member of each pair contains the signal of unknown phase, the two values defined above, (pair−amp) and (pair+amp), are used in a compound comparison against defined limit values to statistically estimate which coding phase is more likely in each n Hertz cycle bit of the FIG. 3 and FIG. 4 experiments. Specifically, (pair−amp) and (pair+amp) are the two alternative estimates of the change in the others when the signal is transitioning from 0 to either +amp or −amp, or from +amp or −amp to 0. When the likelihood is ambiguous from these two estimates of the others, then no scores are incremented. Thus, scores are incremented only when one estimate is far more likely than the other estimate.

In a compound comparison, when (pair1+amp) is greater than (1.2*amp) and (pair1−amp) is less than (0.3*amp), then increment one count to the In-Phase Score. When the above condition is satisfied, add one more count to the In-Phase Score if (pair1−amp) is less than (0.2*amp), and add a third count to the In-Phase Score if (pair1−amp) is less than (0.1*amp), for the phase coding experiments of FIG. 3 and FIG. 4.

To better appreciate what the above comparisons are numerically doing with regard to pair1, consider the following illustrating example. Let the forward On A/D be 100, the rear π/2 A/D be 70 and the signal amp be 40. The absolute value of (100−70−40) is 10=(pair1−amp). The absolute value of (100−70+40) is 70=(pair1+amp). Now 1.2*40 is 48 and 0.3*40 is 12. In the compound comparison, 70 is greater than 48 AND 10 is less than 12. Then, accepting that this compound comparison has implied in phase coding, the others in the rear element A/D would have been 70−40=30. No bonus is added to the In-Phase Score as the (pair1−amp) value of 10 is not less than 0.2*40=8. Now we can see why the compound comparison rule found the out of phase coding less likely. The rear element others would have been 70+40=110. The others composite amplitude being 100 in the forward element and 110 in the rear element is much less likely than being 100 in the forward element and then 30 in the rear element, as such a low frequency amplitude change would have required a new strong transmitter to appear in the very short propagation time between the forward and rear antenna elements.

Continuing this illustrative example, if the rear A/D was 30 instead of 70 above, the pair1 is somewhat ambiguous as (pair1+amp) is 110 but (pair1−amp) is 30, which is greater than 12. The ambiguity comes from where the others would have transitioned from 100 to −10 in the time that the signal transitioned from 0 to 40. However, if the rear A/D were 60, then (pair1−amp) would be 0 and (pair1+amp) would be 80. Here 2 bonus counts are awarded. The reason is that the others transition from 100 to 20 is far more likely than the others transitioning from 100 to 120 while the signal transitioned from 0 to 40. The others from 100 to 20 is also more likely than the transition from 100 to −10 (above with rear A/D at 30) that did not meet the compound criteria for a score count.

The above compound comparison structure is identical for pair3, that is, when (pair3+amp) is greater than (1.2*amp) and (pair3−amp) is less than (0.3*amp), then add one to the In-Phase Score. When this specific compound condition is satisfied, a second and third count can be added when (pair3−amp) is less than (0.2*amp) or less than (0.1*amp), as above for pair1.

But when (pair1−amp) is greater than (1.2*amp) and (pair1+amp) is less than (0.3*amp), then increment one count to the Out-Phase Score. When the above condition is satisfied, add one more count to the Out-Phase Score when (pair1+amp) is less than (0.2*amp), and add a third count to the Out-Phase Score when (pair1+amp) is less than (0.1*amp). These conditions are identical for pair3.

All of the above comparisons are of the same form for pair2 and pair4, except that they apply to the Out-Phase Score as these pairs where computed from the 3π/2 A/D samples, instead of the π/2 A/D samples. Now, when (pair2+amp) is greater than (1.2*amp) and (pair2−amp) is less than (0.3*amp), increment one count to the Out-Phase Score. When the above condition is satisfied, add one more count to the Out-Phase Score when (pair2−amp) is less than (0.2*amp), and add a third count to the Out-Phase Score when (pair2−amp) is less than (0.1*amp).

When (pair2−amp) is greater than (1.2*amp) and (pair2+amp) is less than (0.3*amp), then increment one count to the In-Phase Score. When the above condition is satisfied, add one more count to the In-Phase Score when (pair2+amp) is less than (0.2*amp), and add a third count to the In-Phase Score when (pair2+amp) is less than (0.1*amp).

The maximum counts for the In-Phase and Out-Phase scores from the Correlation computation are 4 pairs*3 counts*n Hertz cycles=12n. The combined maximum scores are 12 from the Average computation plus 12n from the Correlation computation, for the In-Phase Score and the Out-Phase Score. More scoring is allowed for the Correlation computation than for the Average computation because it uses element pairs as opposed to just the elements separately. The maximum score in the FIG. 3 experiment is 12+36=48. The largest In-Phase score realized was 22 of 48 in bit 6 of FIG. 3. The maximum score in the FIG. 4 experiment is 12+60=72. The largest Out-Phase score realized was 24 of 72 in bit 3 of FIG. 4.

The multipliers of 1.2, 0.2 and 0.1 are determined experimentally to achieve the best result. By “best result” is meant that the determined multipliers when applied to received encoded data bits cause the Correlation Calculation to achieve a desired level of correspondence of the decoded data bits matching the encoded data bits. For example, a predetermined sequence of data bits can be sent and the optimum multipliers determined that best return the predetermined sequence of data bits. As necessary, the number of cycles, n, for coding each data bit also can be changed. The multipliers and number of coding cycles can be different depending on the levels of unwanted other noise received by the antennae. Accordingly, the multipliers and number of coding cycles can be re-determined whenever it is useful to do so.

In the on/off coding experiment of FIG. 5, when pair1 or pair3 is greater than (0.65*amp) then increment the On-Score by 1 count, and add a second count to the On-Score when the absolute value pair1 or pair3 is greater than (0.85*amp). When pair2 or pair4 is less than (−0.65*amp) then increment the On-Score by 1 count, and add a second count to the On-Score when the absolute value pair2 or pair4 is less than (−0.85*amp). When the absolute value of any pair is less than (0.35*amp), then add one count to the Off-Score, and add a second count to the Off-Score when the absolute value of any pair is less than (0.15*amp).

In on/off coding, the maximum scores from the Correlation computation are 4 pairs*2 counts*n Hertz cycles=8n. The combined maximum scores are 12 from the Average computation plus 8n from the Correlation computation, for the On-Score and the Off-Score. The maximum score for the FIG. 5 experiment is 12+48=60. The largest Off-Score realized was 27 of 60 in bit 3 of FIG. 5. The maximum 60 minus a score is an indication of the amount of random ambiguity from the others that was present in the antenna elements, such that no counts were added to a score when the computations were ambiguous. Counts were only added when a computational indication was strong.

Accordingly, when the signal amplitude in FIG. 5 was doubled from 50 to 100 vertical pixels (a much stronger received signal relative to the others), the bit 3 Off-Score rose to 45 of 60, and the On-Score of bit 3 dropped from 3 to the minimum value of zero, a 45−0=45 bit detection margin compared to the amplitude 50 bit detection margin of 27−3=24. The scores will be lower when the signal amplitude is small compared to the others and the scores will be larger when the signal to noise ratio increases, as in all wireless transmissions. Likewise, coding a bit in more Hertz cycles n generally increases the signal to noise ratio and the score discriminations, at the expense of a lower data rate at the interface 260.

The multipliers of 0.85, 0.65, 0.35 and 0.15 are determined experimentally to achieve the best result. For example, a predetermined sequence of bits can be sent and the optimum multipliers determined that best return the predetermined sequence of bits. As necessary, the number of cycles, n, for coding each bit also can changed. The multipliers and number of coding cycles can be different depending on the levels of unwanted other noise received by the antennae. Accordingly, the multipliers and number of coding cycles can be re-determined as necessary.

It should be appreciated that additional A/D samples could be used to refine the computations. It should further be appreciated that a number of additional similar scores and various other limits for the detection comparisons could be defined within the spirit and scope of the present disclosure. For example, an embodiment with 8 A/D samples might better resolve the phase and amplitude of the others in an A/D sample, at the cost of added A/D hardware. Such an 8 A/D sample embodiment might help in this regard by more closely revealing the zero crossings of the others, which are at random phase relative to the transmitted signal.

Other implementations are within the scope of the following claims.

What is claimed is:

1. A frequency specific receiver to receive a transmitted polarized carrier signal wave, the carrier signal wave having a carrier frequency, encoding one or more data bits, comprising:
a synchronization filter to determine a reference time at 0π of the carrier signal wave from a forward wave received at a forward antenna element and a rear wave received at a rear antenna element, the forward antenna element and the rear antenna element positioned apart from one another by a distance of ¼ wavelength of the transmitted polarized carrier signal wave and oriented in a polarization direction of the transmitted polarized carrier signal wave;
a first analog-to-digital (A/D) converter to sample the forward wave at π/2, π, 3π/2 and 2π radians from a reference time;
a second A/D converter to sample the rear wave at π/2, π, 3π/2 and 2π radians from the reference time;
a control processor configured to decode a value of the encoded data bit by calculation of an Average Computation and a calculation of a Correlation Computation based on a received amplitude; and
an output interface for outputting the value of the data bit to a user,
wherein the data bit is encoded over n cycles of the carrier wave signal.

2. The frequency specific receiver of claim 1, wherein the control processor calculation of the Average Computation includes:
calculating a first forward wave average of a first forward wave sum of the π/2 A/D converter samples across the n cycles that encode the data bit and dividing the first forward wave sum by n,
calculating a first rear wave average of a first rear wave sum of the π/2 A/D converter samples across the n cycles that encode the data bit and dividing the first rear wave sum by n,
calculating a second forward wave average of a second forward wave sum of the 3π/2 A/D converter samples across the n cycles that encode the data bit and dividing the second forward wave sum by n,
calculating a second rear wave average of a second rear wave sum of the 3π/2 A/D converter samples across the n cycles that encode the data bit and dividing the second rear wave sum by n.

3. The frequency specific receiver of claim 2,
wherein, when the data bit is phase encoded in the carrier wave signal, then the control processor calculation of the Average Computation includes:
a. an In-Phase Score is incremented based on a comparison of the first forward wave average with one or more predetermined average In-Phase levels,
b. the In-Phase Score is incremented based on a comparison of the first rear wave average with one or more predetermined average In-Phase levels,
c. an Out-Phase Score is incremented based on a comparison of the second forward wave average with one or more predetermined average Out-Phase levels, and
d. the Out-Phase Score is incremented based on a comparison of the second rear wave average with one or more predetermined average Out-Phase levels.

4. The frequency specific receiver of claim 3,
wherein the one or more average In-Phase levels are respective average In-Phase multipliers of the received amplitude, and
wherein the one or more average Out-Phase levels are respective average Out-Phase multipliers of the received amplitude.

5. The frequency specific receiver of claim 4, wherein the respective average In-Phase multipliers and the respective average Out-Phase multipliers are determined by receiving a predetermined sequence of data bits and determining the respective average multipliers that best return the predetermined sequence of data bits.

6. The frequency specific antenna of claim 2,
wherein, when the data bit is on/off encoded in the carrier wave signal, then the control processor calculation of the Average Computation includes:
a. an On-Score is incremented based on a comparison of the first forward wave average with one or more predetermined average On-Score levels,
b. the On-Score is incremented based on a comparison of the first rear wave average with one or more predetermined average On-Score levels,
c. the On-Score is incremented based on a comparison of the second forward wave average with one or more predetermined average On-Score levels,
d. the On-Score is incremented based on a comparison of the second rear wave average with one or more predetermined average On-Score levels.
e. an Off-Score is incremented based on a comparison of the first forward wave average with one or more predetermined average Off-Score levels,
f. the Off-Score is incremented based on a comparison of the first rear wave average with one or more predetermined average Off-Score levels,
g. the Off-Score is incremented based on a comparison of the second forward wave average with one or more predetermined average Off-Score levels, and
h. the Off-Score is incremented based on a comparison of the second rear wave average with one or more predetermined average Off-Score levels.

7. The frequency specific receiver of claim 6,
wherein the one or more average On-Score levels are respective average On-Score multipliers of the received amplitude, and
wherein the one or more average Off-Score levels are respective average Off-Score multipliers of the received amplitude.

8. The frequency specific receiver of claim 7, wherein the respective average On-Score multipliers and the respective average Off-Score multipliers are determined by receiving a predetermined sequence of data bits and determining the respective average multipliers that best return the predetermined sequence of data bits.

9. The frequency specific receiver of claim 3, wherein the control processor calculation of the Correlation Computation includes:
pairing the A/D converter sample of the forward wave at π/2, π, 3π/2 and 2π radians with the rear wave A/D converter sample at π/2, π, 3π/2 and 2π radians so that the rear wave A/D converter sample is ¼ wavelength and π/2 in signal propagation behind the respective paired forward wave A/D converter sample.

10. The frequency specific receiver of claim 9, wherein the pairings are:
Pair1: the forward wave A/D sample at 0π with the rear wave A/D sample at π/2,
Pair2: the forward wave A/D sample at 1π with the rear wave A/D sample at 3π/2,
Pair3: the forward wave A/D sample at π/2 with the rear wave A/D sample at 1π, and
Pair4: the forward wave A/D sample at 3π/2 with the rear wave A/D sample at 2π.

11. The frequency specific receiver of claim 10, wherein, when the data bit is phase encoded in the carrier wave signal, then the control processor calculation of the Correlation Computation includes:
incrementing the In-Phase Score based on a comparison of an arithmetic combination of A/D converter samples in each pair with one or more predetermined correlation In-Phase levels; and
incrementing the Out-Phase Score based on a comparison of an arithmetic combination of A/D converter samples in each pair with one or more predetermined correlation Out-Phase levels.

12. The frequency specific receiver of claim 11, wherein the value of the data bit is determined from a comparison of the In-Phase Score to the Out-Phase Score.

13. The frequency specific receiver of claim 12,
wherein the one or more correlation In-Phase levels are respective correlation In-Phase multipliers of the received amplitude, and
wherein the one or more correlation Out-Phase levels are respective correlation Out-Phase multipliers of the received amplitude.

14. The frequency specific receiver of claim 13, wherein the respective correlation In-Phase multipliers and the respective correlation Out-Phase multipliers are determined by receiving a predetermined sequence of data bits and determining the respective correlation multipliers that best return the predetermined sequence of data bits.

15. The frequency specific receiver of claim 10, wherein, when the data bit is on/off encoded in the carrier wave signal, then the control processor calculation of the Correlation Computation includes:
incrementing the On-Score based on a comparison of an arithmetic combination of A/D converter samples in each pair with one or more predetermined correlation On-Score levels; and
incrementing the Off-Score based on a comparison of an arithmetic combination of A/D converter samples in each pair with one or more predetermined correlation Off-Score levels.

16. The frequency specific receiver of claim 15, wherein the value of the data bit is determined from a comparison of the On-Score to the Off-Score.

17. A method of decoding one or data bits from a transmitted polarized carrier signal wave, the carrier signal wave having a carrier frequency, encoding the one or more data bits, comprising:
synchronizing a reference time at 0π of the carrier signal wave from a forward wave received at a forward antenna element and a rear wave received at a rear antenna element, the forward antenna element and the rear antenna element positioned apart from one another by a distance of ¼ wavelength of the transmitted polarized carrier signal wave and oriented in a polarization direction of the transmitted polarized carrier signal wave;
sampling with a first analog-to-digital (A/D) converter the forward wave at π/2, π, 3π/2 and 2π radians from a reference time;
sampling with a second A/D converter the rear wave at π/2, π, 3π/2 and 2π radians from the reference time;
decoding a value of the encoded data bit by calculation of an Average Computation and a calculation of a Correlation Computation based on a received amplitude; and
outputting the value of the data bit to a user.

18. The method of claim 17, wherein calculation of the Average Computation comprises:
calculating a first forward wave average of a first forward wave sum of the π/2 A/D converter samples across the n cycles that encode the data bit and dividing the first sum by n,
calculating a first rear wave average of a first rear wave sum of the π/2 A/D converter samples across the n cycles that encode the data bit and dividing the first sum by n,
calculating a second forward wave average of a second forward wave sum of the 3π/2 A/D converter samples across the n cycles that encode the data bit and dividing the second sum by n,
calculating a second rear wave average of a second rear wave sum of the 3π/2 A/D converter samples across the n cycles that encode the data bit and dividing the second sum by n.

19. The method of claim 18, wherein, when the data bit is phase encoded in the carrier wave signal, then calculation of the Average Computation further comprises:
a. incrementing an In-Phase Score based on a comparison of the first forward wave average with one or more predetermined average In-Phase levels,
b. incrementing the In-Phase Score based on a comparison of the first rear wave average with one or more predetermined average In-Phase levels,
c. incrementing an Out-Phase Score based on a comparison of the second forward wave average with one or more predetermined average Out-Phase levels, and
d. incrementing the Out-Phase Score based on a comparison of the second rear wave average with one or more predetermined average Out-Phase levels.

20. The method of claim 19,
wherein the one or more average In-Phase levels are respective average In-Phase multipliers of the received amplitude, and
wherein the one or more average Out-Phase levels are respective average Out-Phase multipliers of the received amplitude.

21. The method of claim 20, wherein the respective average In-Phase multipliers and the respective average Out-Phase multipliers are determined by receiving a predetermined sequence of data bits and determining the respective average multipliers that best return the predetermined sequence of data bits.

22. The method of claim 18,
wherein, when the data bit is on/off encoded in the carrier wave signal, then calculation of the Average Computation further comprises:
a. incrementing an On-Score based on a comparison of the first forward wave average with one or more predetermined average On-Score levels,
b. incrementing the On-Score based on a comparison of the first rear wave average with one or more predetermined average On-Score levels,
c. incrementing the On-Score based on a comparison of the second forward wave average with one or more predetermined average On-Score levels,
d. incrementing the On-Score based on a comparison of the second rear wave average with one or more predetermined average On-Score levels.
e. incrementing an Off-Score based on a comparison of the first forward wave average with one or more predetermined average Off-Score levels,
f. incrementing the Off-Score based on a comparison of the first rear wave average with one or more predetermined average Off-Score levels,
g. incrementing the Off-Score based on a comparison of the second forward wave average with one or more predetermined average Off-Score levels, and
h. incrementing the Off-Score based on a comparison of the second rear wave average with one or more predetermined average Off-Score levels.

23. The method of claim 22,
wherein the one or more average On-Score levels are respective average On-Score multipliers of the received amplitude, and
wherein the one or more average Off-Score levels are respective average Off-Score multipliers of the received amplitude.

24. The frequency specific receiver of claim 23, wherein the respective average On-Score multipliers and the respective average Off-Score multipliers are determined by receiving a predetermined sequence of data bits and determining the respective average multipliers that best return the predetermined sequence of data bits.

25. The method of claim 18, wherein calculation of the Correlation Computation comprises:
pairing the A/D converter sample of the forward wave at π/2, π, 3π/2 and 2π radians with the rear wave A/D converter sample at π/2, π, 3π/2 and 2πradians so that the rear wave A/D converter sample is 74 wavelength and π/2 in signal propagation behind the respective paired forward wave A/D converter sample;

26. The method of claim 25, wherein the pairings are:
Pair1: the forward wave A/D sample at 0π with the rear wave A/D sample at π/2;
Pair2: the forward wave A/D sample at 1π with the rear wave A/D sample at 3π/2;
Pair3: the forward wave A/D sample at π/2 with the rear wave A/D sample at 1π; and
Pair4: the forward wave A/D sample at 3π/2 with the rear wave A/D sample at 2π.

27. The method of claim 26, wherein, when the data bit is phase encoded in the carrier wave signal, calculation of the Correlation Computation further comprises:
incrementing the In-Phase Score based on a comparison of an arithmetic combination of A/D converter samples in each pair with one or more predetermined correlation In-Phase levels; and
incrementing the Out-Phase Score based on a comparison of an arithmetic combination of A/D converter samples in each pair with one or more predetermined correlation Out-Phase levels.

28. The frequency specific receiver of claim 27, wherein the value of the data bit is determined from a comparison of the In-Phase Score to the Out-Phase Score.

29. The method of claim 28,
wherein the one or more correlation In-Phase levels are respective correlation In-Phase multipliers of the received amplitude, and
wherein the one or more correlation Out-Phase levels are respective correlation Out-Phase multipliers of the received amplitude.

30. The method of claim 29, wherein the respective correlation In-Phase multipliers and the respective correlation Out-Phase multipliers are determined by receiving a predetermined sequence of data bits and determining the respective correlation multipliers that best return the predetermined sequence of data bits.

31. The method of claim 26, wherein, when the data bit is on/off encoded in the carrier wave signal, then the control processor calculation of the Correlation Computation includes:
incrementing the On-Score based on a comparison of an arithmetic combination of A/D converter samples in each pair with one or more predetermined correlation On-Score levels; and
incrementing the Off-Score based on a comparison of an arithmetic combination of A/D converter samples in each pair with one or more predetermined correlation Off-Score levels.

32. The method of claim 31, wherein the value of the data bit is determined from a comparison of the On-Score to the Off-Score.

33. A frequency specific antenna to receive a first transmitted polarized carrier signal wave encoding one or more data bits, comprising:
a first forward antenna element;
a first rear antenna element electrically isolated from the first forward antenna element, the first forward antenna element and the first rear antenna element positioned apart from one another by a distance of ¼ wavelength of the transmitted polarized carrier signal wave and oriented in a first polarization direction of the transmitted polarized carrier signal wave;
a synchronization filter to determine a reference time at 0π from a first forward wave received at the first forward antenna element and a first rear wave received at the rear antenna element;
a receiver to decode a value of the encoded data bit from the transmitted polarized carrier signal wave by operation on the synchronized first forward wave and first rear wave; and
an output interface for outputting the value of the decoded data bit to a user.

34. The frequency specific antenna of claim 33, wherein the first forward antenna element and the first rear antenna element are offset from one another in the first polarization direction.

35. The frequency specific antenna of claim 34, comprising:
a second forward antenna element configured to receive a second forward wave;
a second rear antenna element configured to receive a second rear wave and electrically isolated from the second forward antenna and positioned a distance therefrom of ¼ wavelength of a second transmitted polarized carrier signal wave,
wherein second forward antenna element and the second rear antenna element are oriented 90 degrees to the first forward antenna element and the first rear antenna element to receive, substantially simultaneously with the first transmitted polarized carrier signal, the second transmitted polarized carrier signal wave transmitted in a second polarization direction orthogonal to the transmitted polarized carrier signal wave.
